(19) United States
(12) Patent Application Publication
(10) Pub. No.: US 2024/0255743 A1
(43) Pub. Date: Aug. 1, 2024

(54) CONFOCAL MICROSCOPE AND A METHOD OF ADJUSTING A CONFOCAL MICROSCOPE

(71) Applicant: LEICA MICROSYSTEMS CMS GMBH, Wetzlar (DE)

(72) Inventors: Cornell Peter GONSCHIOR, Wetzlar (DE); Alexander WEISS, Wetzlar (DE)

(21) Appl. No.: 18/424,944

(22) Filed: Jan. 29, 2024

(30) Foreign Application Priority Data
Feb. 1, 2023 (DE) 102023102418.3

(51) Int. Cl. G02B 21/00

(52) U.S. Cl. CPC G02B 21/0032; G02B 21/0076; G02B 21/008

(57) ABSTRACT

A confocal microscope includes an illumination unit configured to generate an illumination light bundle, an imaging optics configured to receive detection light, a scanner configured to deflect the illumination light bundle to generate a scanning illumination and to direct the detection light into a detection beam path, a sensor disposed in the detection beam path, a pinhole diaphragm arranged in the detection beam path upstream of the sensor, an adjustable light deflector arranged in the detection beam path and configured to direct the detection light through the pinhole diaphragm onto the sensor, and a controller configured to control the scanner to adjust the confocal microscope in such a manner that the illumination light bundle is directed onto a test object, and control the light deflector in such a manner that an intensity of the detection light coming from the test object, as detected by the sensor, is optimized.

### CROSS REFERENCE TO RELATED APPLICATIONS

This application claims benefit to German Patent Application No. DE 102023102418.3, filed on Feb. 1, 2023, which is hereby incorporated by reference herein.

### FIELD

Embodiments of the present invention relate to a confocal microscope, and to a method of adjusting a confocal microscope.

### BACKGROUND

A confocal microscope typically comprises a pinhole diaphragm to block detection light not coming from the focal plane. For the pinhole diaphragm to be able to fulfil this function, optical elements in the detection beam path of the confocal microscope need to be precisely adjusted. The adjustment serves to adjust the confocal microscope to obtain an image of a higher grade. The adjustment of the optical elements can be performed, in particular, during manufacture. In the process, the optical elements are fixed with respect to the pinhole diaphragm and to a sensor element of the confocal microscope after completion of adjustment. This has the drawback that, when the position of the pinhole diaphragm or any of the other optical elements of the confocal microscope change, for example, due to transportation of the confocal microscope or due to changed environmental conditions, simple readjustment cannot be performed to achieve imaging quality.

A confocal microscope is known from WO 2022/145391 A1. In the prior-art confocal microscope, the pinhole diaphragm is formed by a membrane. Furthermore, a method of adjusting the prior-art confocal microscope is disclosed, wherein the diameter and the position of the pinhole diaphragm relative to the sensor element are adjusted. By adjusting the position of the pinhole diaphragm relative to the sensor element, an inhomogeneousness of the sensor element or an optics arranged between that pinhole diaphragm and the sensor element can negatively affect imaging quality.

### SUMMARY

Embodiments of the present invention provide a confocal microscope. The confocal microscope includes an illumination unit configured to generate an illumination light bundle, an imaging optics configured to receive detection light and to guide the detection light to further elements of the confocal microscope, a scanner configured to direct the illumination light bundle into the imaging optics and deflect the illumination light bundle to generate a scanning illumination, and receive the detection light from the imaging optics and direct the detection light into a detection beam path of the confocal microscope, a sensor disposed in the detection beam path, a pinhole diaphragm arranged in the detection beam path upstream of the sensor, an adjustable light deflector arranged in the detection beam path and configured to direct the detection light through the pinhole diaphragm onto the sensor, and a controller configured to control the scanner to adjust the confocal microscope in such a manner that the illumination light bundle is directed onto a test object, and control the light deflector in such a manner that an intensity of the detection light coming from the test object, as detected by the sensor, is optimized.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a confocal microscope according to an exemplary embodiment;

FIG. 2 shows a schematic view of the confocal microscope according to a further exemplary embodiment;

FIG. 3 shows a schematic view of the confocal microscope according to a further exemplary embodiment;

FIG. 4 shows a flowchart of a method for adjusting a confocal microscope according to some embodiments;

FIG. 5 shows a flowchart of a sub-method of the method of FIG. 3 according to a first exemplary embodiment; and

FIG. 6 shows a flowchart of a sub-method of the method of FIG. 3 according to a second exemplary embodiment.

### DETAILED DESCRIPTION

Embodiments of the present invention provide a confocal microscope and a method of adjusting a confocal microscope which avoids the drawbacks of the above-mentioned prior art.

The provided confocal microscope comprises an illumination unit configured to generate an illumination light bundle, an imaging optics, configured to receive detection light and to guide it to further elements of the confocal microscope, and a scanning unit configured to direct the illumination light bundle into the imaging optics and to deflect it for the generation of a scanning illumination, and to receive the detection light from the imaging optics and to direct it into a detection beam path of the confocal microscope. The confocal microscope also comprises a sensor element disposed in the detection beam path, a pinhole diaphragm arranged in the detection beam path upstream of the sensor element and an adjustable light deflection element arranged in the detection beam path configured to direct the detection light through the pinhole diaphragm onto the sensor element. Furthermore, the confocal microscope comprises a control unit configured to control the scanning unit to adjust the confocal microscope in such a manner that the illumination light bundle is directed onto a test object and to control the light deflection element in such a manner that an intensity, detected by the sensor element, of the detection light coming from the test object is optimized.

Further optical elements can be arranged in the detection beam path. In particular, a transportation optics can be arranged in the detection beam path, for example an optical fiber. The control unit is configured, in particular, to control the light deflection element in such a manner that the intensity, detected by the sensor element, of the detection light coming from the test object is maximized. A de-scanned arrangement is implemented, in particular, by the confocal microscope provided, in this way, independent from the position of the illumination light bundle in the field of view of the confocal microscope, the position of the light beam of the detection light onto the sensor element remains unchanged.

The suggested confocal microscope is adjusted by the adjustment of the light deflection element. Herein, the adjustment of the light deflection element determines how much of the detection light from the focal plane impinges on the sensor through the pinhole diaphragm since no other optical element in the detection beam path substantially changes the position of the detection light beam. In other words, the adjustment of the light deflection element essentially determines the quality of imaging. The adjustment of the confocal microscope can be carried out, in particular, even when the confocal microscope has already been put into operation by a user. The suggested confocal microscope thus allows simple readjustment by the user to achieve the desired quality of imaging. Furthermore, the adjustment of the light deflection element is automatically performed by the control unit. This simplifies the use of the confocal microscope since no manual readjustment is necessary. Furthermore, the position of the pinhole diaphragm remains unchanged by the adjustment. This avoids the drawbacks of a variable pinhole diaphragm in a confocal microscope.

In an embodiment, the control unit is configured to carry out adjustment of the confocal microscope each time the confocal microscope is switched on. Due to temperature variations or transportation of the confocal microscope, readjustment may become necessary. To guarantee optimal adjustment of the light deflection element each time the confocal microscope is put into operation, the control unit in this embodiment carries out readjustment of the confocal microscope by adjusting the light deflection element when the confocal microscope is switched on.

In a further embodiment, the control unit is configured to carry out adjustment of the confocal microscope whenever a predetermined time interval has passed. Alternatively, or in addition to readjustment during start of operation, the control unit carries out adjustment of the light deflection element whenever the predetermined time interval has passed. This is advantageous, in particular, when the confocal microscope is in operation over a long period of time, since, for example, temperature variations during operation may also make readjustment of the confocal microscope necessary via adjustment of the light deflection element. It is thus ensured that imaging quality is maintained even during long periods of operation.

In a further embodiment, the illumination light bundle is configured to excite fluorescent materials to generate fluorescent light. In particular, the illumination light bundle is a laser light beam. Fluorescent materials are, in particular fluorophores. In this embodiment, the confocal microscope is configured as a confocal laser scanning microscope and has the well-known advantages of such a microscope.

In a further embodiment, the test object is excitable by the illumination light bundle to generate fluorescent light. Fluorescent light typically has a well-known spectrum. This enables the fluorescent light emitted by the test object to be separated from other light, in particular scattered light, for example by optical filters or beam splitters. By these means, the adjustment of the confocal microscope can be carried out with high precision.

In a further embodiment, the confocal microscope comprises the test object. The test object is preferably arranged within a housing of the confocal microscope. In this embodiment, the user does not have to introduce the test object into the confocal microscope to be able to adjust the confocal microscope. In particular, the user does not have to remove a specimen from the confocal microscope and replace it by a special technical specimen with the test object. This facilitates, in particular, automation of the adjustment of the confocal microscope. Generally, user-friendliness of the confocal microscope improves when the test object is part of the confocal microscope itself.

In a further embodiment, the illumination unit comprises an illumination light source, in particular a laser light source, configured to generate illumination light. The illumination unit is further configured to shape illumination light generated by the illumination light source to create the illumination light bundle. In this embodiment, the illumination light source is part of the confocal microscope itself. The confocal microscope according to this embodiment forms an integral unit which comprises all the elements necessary for imaging. This makes the confocal microscope easy to handle.

In a further embodiment, the illumination unit comprises an interface, in particular a fiber coupler, with the aid of which the confocal microscope can be connected to an external illumination light source. The illumination unit is further configured to shape illumination light generated by the external illumination light source to create the illumination light bundle. The external illumination light source is, in particular, a laser light source. In this embodiment, the illumination light source is not part of the confocal microscope. The illumination light generated by the illumination light source is coupled into the confocal microscope via the interface and then shaped to create the illumination light bundle by the illumination unit. This embodiment allows the user to combine the confocal microscope with a plurality of different illumination light sources to be able to select the optimal illumination light source for each application. The confocal microscope according to this embodiment is thus flexible.

In a further embodiment, the confocal microscope comprises a beam splitter configured to direct the illumination light bundle onto the scanning element and to direct the detection light received from the imaging optics into the detection beam path. In particular, the confocal microscope comprises a dichroic beam splitter. In an alternative embodiment, the confocal microscope can also include a neutral splitter configured to direct at least part of the illumination light bundle onto the scanning element and to direct at least part of the detection light received from the imaging optics into the detection beam path.

Embodiments of the invention also relate to a method of adjusting the above-described confocal microscope, wherein the illumination light bundle is directed onto the test object and the light deflection element is adjusted until the intensity, detected by the sensor element, of the detection light coming from the test object is optimized. In particular, the light deflection element is adjusted until the intensity, detected by the sensor element, of the detection light coming from the test object is maximized. The suggested method has the same advantages as the above-described confocal microscope and can be further developed, in particular, with the features of the dependent claims directed to the confocal microscope. In reverse, the confocal microscope can also be further developed with the features of the dependent Claim directed to the method. The steps of this method can be carried out, in particular by the control unit of the above-described confocal microscope.

In an embodiment, to adjust the confocal microscope, the following steps are executed: a) Adjusting the light deflection element in a plurality of successive steps at a predetermined step width along a first axis within a first adjustment range. b) Detecting the intensity of the detection light coming from the test object in each step along the first axis. c) Adjusting the light deflection element to a position along the first axis, for which the detected intensity of the detection light coming from the test object is at a maximum. d) Adjusting the light deflection element in a plurality of successive steps at a predetermined second step width along a second axis within a second adjustment range. e) Detecting the intensity of the detection light coming from the test object in each step along the second axis. f) Adjusting the light deflection element to a position along the second axis, for which the detected intensity of the detection light coming from the test object is at a maximum. Preferably, steps a) to f) are repeated until each change in position in steps c) and f) is smaller than a predetermined value. The first axis and the second axis are for example, tilting axes of the light deflection element. The adjustment of the light deflection element is carried out in an alternating fashion along the first axis and the second axis until the change of the detected intensity is smaller than the predetermined value, i.e., until an essential improvement in the imaging quality can no longer be achieved by adjusting the light deflection element. In other words, in the present embodiment, the adjustment of the light deflection element for adjusting the confocal microscope is iterative. The iterative adjustment of the light deflection element is rapid, in particular, when only a small readjustment of the confocal microscope is necessary.

In a further embodiment, the first adjustment range and/or the second adjustment range is enlarged and steps a) to g) are repeated if the intensities detected in each of steps b) and e) have a value that is smaller than a predetermined intensity value and/or if a maximum cannot be determined in steps c) and/or f). The predetermined intensity value is determined as a function of an expected intensity of the detection light coming from the test object. Furthermore, the predetermined intensity value can be determined as a function of the intensity of the illumination light beam. If during iterative adjustment of the light deflection element the predetermined intensity value is not exceeded, or a maximum cannot be determined, the light deflection element has been moved out of its optimal adjustment, for example, by transportation or changes in environmental conditions, by an amount that is larger than an adjustment within the first adjustment range and/or the second adjustment range is able to correct. By enlarging the first adjustment range and/or the second adjustment range, optimal adjustment of the light deflection element can then be determined.

In a further embodiment, the diameter of the pinhole diaphragm is enlarged and steps a) to g) are repeated if the intensities detected in each of steps b) and e) have a value that is smaller than a predetermined intensity value and/or if a maximum cannot be determined in steps c) and/or f). In addition to the adjustment of the light deflection element, further steps for adjusting the confocal microscope may become necessary. A further adjustment which can be carried out for adjusting the confocal microscope, is to change the diameter of the pinhole diaphragm. In this embodiment, the diameter of the pinhole diaphragm is therefore enlarged if the predetermined intensity value is not exceeded or a maximum cannot be determined during iterative adjustment of the light deflection element.

In an embodiment, for adjusting the confocal microscope the following steps are executed: a) Adjusting the light deflection element in a plurality of successive steps at a predetermined step width along a first axis within a first adjustment range. b) Detecting the intensity of the detection light coming from the test object in each step along the first axis. c) Adjusting the light deflection element at a predetermined step width along a second axis. d) Repeating steps a) to c) until the light deflection element has been adjusted along the second axis by a predetermined value which corresponds to a second adjustment range. e) Determining a two-dimensional intensity distribution from each of the intensities detected in step b). f) Determining a center of gravity or a maximum in the two-dimensional intensity distribution. g) Adjusting the light deflection element to a position along the first axis and the second axis corresponding to the center of gravity or the maximum of the two-dimensional intensity distribution. The two-dimensional intensity distribution can be generated, for example, by interpolation or a fit to a theoretical intensity distribution from the detected intensities. In this embodiment, the adjustment of the light deflection element for adjusting the confocal microscope is carried out on the basis of the determined intensity distribution. The adjustment on the basis of the determined intensity distribution can be alternatively or additionally carried out for the iterative adjustment of the light deflection element. In comparison with the iterative adjustment, the adjustment of the light deflection element on the basis of the determined intensity distribution has the advantage that the global maximum of the intensity distribution can be used as a basis for the adjustment of the light deflection element with substantial reliability. Also, during iterative adjustment, it is not possible to use the center of gravity of the intensity distribution as a basis for the adjustment of the light deflection element.

In a further embodiment, the first adjustment range and/or the second adjustment range are enlarged and steps a) to g) are repeated if each of the intensities detected in step e) have a value that is smaller than a predetermined intensity value and/or if a center of gravity or a maximum cannot be determined in step f). Enlarging the first adjustment range and/or the second adjustment range, has the effect of enlarging the range within which the center of gravity or the maximum of the intensity distribution is looked for. By these means, an optimal adjustment of the light deflection element can be found if in a first iteration of adjustment the center of gravity or the maximum of the intensity distribution is still outside of the intensity distribution determined in this iteration.

In a further embodiment, the diameter of the pinhole diaphragm is enlarged and steps a) to g) are repeated if each of the intensities detected in step e) have a value that is smaller than a predetermined intensity value and/or if a center of gravity or a maximum cannot be determined in step f). In the same way as in the iterative adjustment, in this embodiment, the diameter of the pinhole diaphragm is enlarged, if a center of gravity or maximum cannot be determined to adjust the confocal microscope.

Further features and advantages can be derived from the following description which explains in more detail exemplary embodiments in combination with the accompanying drawings.

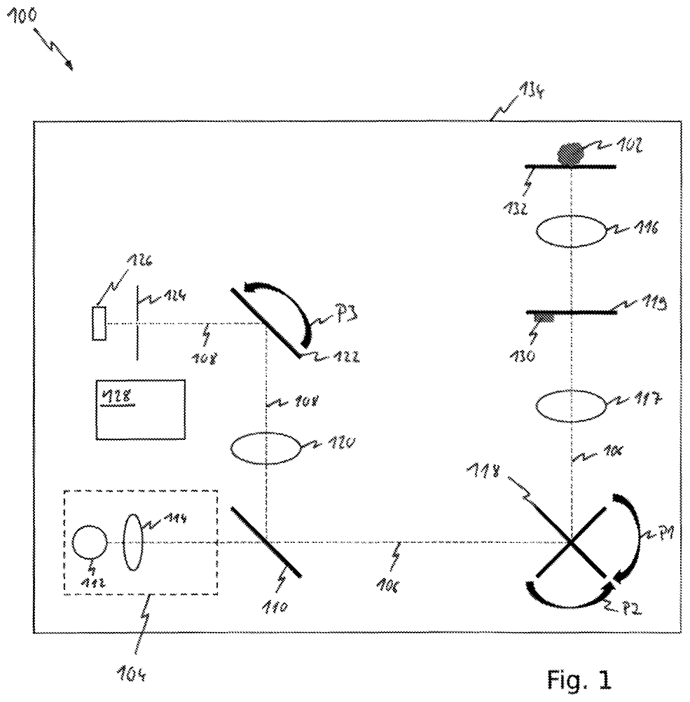

FIG. 1 shows a schematic view of a confocal microscope 100 according to an exemplary embodiment.

In the exemplary embodiment shown, the confocal microscope 100 is configured, purely by way of example, as a confocal laser scanning microscope. To generate an image of a specimen 102 with the aid of the confocal microscope 100, the specimen 102 is illuminated with the aid of an illumination light beam in a scanning manner so that the specimen 102 is illuminated with a small light spot one portion at a time. The confocal microscope 100 images each illuminated portion of the specimen 102 and generates a combined image of the specimen 102 from the thus generated individual images.

The confocal microscope 100 comprises an illumination unit 104 to generate the illumination light beam, a main beam path 106 and a detection beam path 108. The detection beam path 108 is generated by a beam splitter 110, referred to as the primary beam splitter in the context of confocal microscopy, from the main beam path 106 in which the beam splitter 110 separates illumination light and detection light coming from the specimen 102.

The illumination unit 104 comprises an illumination light source 112 to generate the illumination light. In the exemplary embodiment shown, the illumination unit 104 further comprises an optical element 114, for example a collimator lens, configured to generate the illumination light beam from the illumination light. The beam splitter 110 of the confocal microscope 100 receives the illumination light beam and directs it into the main beam path 106 of the confocal microscope 100 towards the specimen 102.

The main beam path 106 of the confocal microscope 100, as seen from the specimen 102, comprises an objective 116, a scanning ocular 117 and a scanning unit 118. The scanning unit 118 receives the illumination light beam from the beam splitter 110 and directs the illumination light beam through the scanning ocular 117 into the objective 116 to illuminate the specimen 102. An intermediate image 119 is generated between the objective 116 and the scanning ocular. The scanning unit 118 is configured to move the illumination light beam by deflection within the field of view of the confocal microscope 100. The movement of the illumination light beam generates the scanning illumination of the specimen 102. In the exemplary embodiment shown, the scanning unit 118 is formed, purely by way of example, as a drivable micro scanner. The movement of the scanning unit 118 is shown by two arrows P1, P2 in FIG. 1.

The objective 116 receives the detection light coming from the specimen 102 and directs the detection light through the scanning ocular 117 onto the scanning unit 118. The scanning unit 118 directs the detection light back to the beam splitter 110 thus causing the detection light to be deflected into the detection beam path 108. The scanning unit 118 is arranged in the main beam path 106 and configured in such a manner that the detection light coming from the specimen 102 is de-scanned so that the detection light is always imaged onto a fixed point despite the movement of the scanning unit 118.

The detection beam path 108 comprises a pinhole diaphragm optics 120, an adjustable light deflection element 122, a pinhole diaphragm 124 and a sensor element 126. The light deflection element 122 directs the detection light coming from the beam splitter 110 onto the pinhole diaphragm 124. An infinity beam path is thus formed between the scanning ocular 117 and the pinhole diaphragm optics 120. The pinhole diaphragm optics, in turn, focuses this infinity beam path to the pinhole diaphragm 124 which blocks a portion of the detection light and lets the rest of the detection light impinge onto the sensor element 126. The objective 116 and the pinhole diaphragm optics 120 are thus part of an imaging optics of the confocal microscope 100. When the confocal microscope 100 is optimally adjusted, only light from the focal plane of the objective 116 passes onto the sensor element 126. In particular, by adjusting the light deflection element 122, the confocal microscope 100 can be adjusted. The movement of the light deflection element 122 for adjustment is shown by an arrow P3 in FIG. 1.

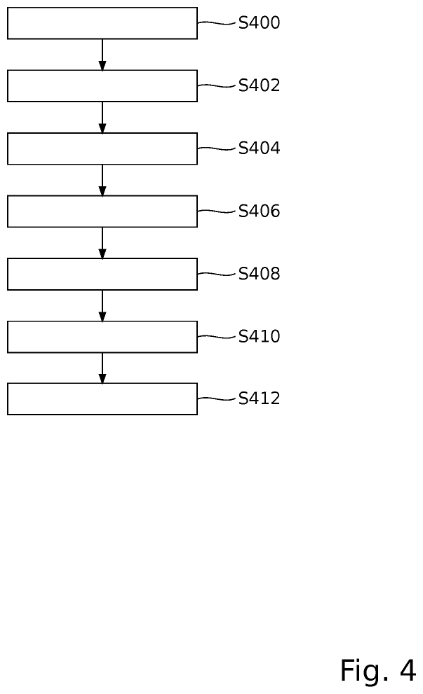

A control unit 128 of the confocal microscope 100 is connected at least with the illumination unit 104, the scanning unit 118 and the light deflection element 122 and configured to drive the aforementioned elements 104, 118, 122 of the confocal microscope 100. The control unit 128 is further configured to carry out a method for adjusting the confocal microscope 100. In the method, the illumination light bundle is directed onto a test object 130 arranged in the plane of the intermediate image 119, the test object 130 being able to be excited to fluorescence by the illumination light. The light deflection element 122 is adjusted until an intensity, detected by the sensor element 126, of the detection light coming from the test object 130 has been maximized. The method for adjusting the confocal microscope 100 will be described in more detail in the following with reference to FIGS. 4, 5 and 6.

The confocal microscope 100 further comprises a microscope table 132 on which the specimen 102 is arranged. In an embodiment of the confocal microscope 100, the test object 130 can also be arranged on the side of the microscope table 132 facing the objective 116. All elements of the confocal microscope 100 are arranged within a housing 134 purely by way of example. The confocal microscope 100 thus forms a so-called box-type microscope.

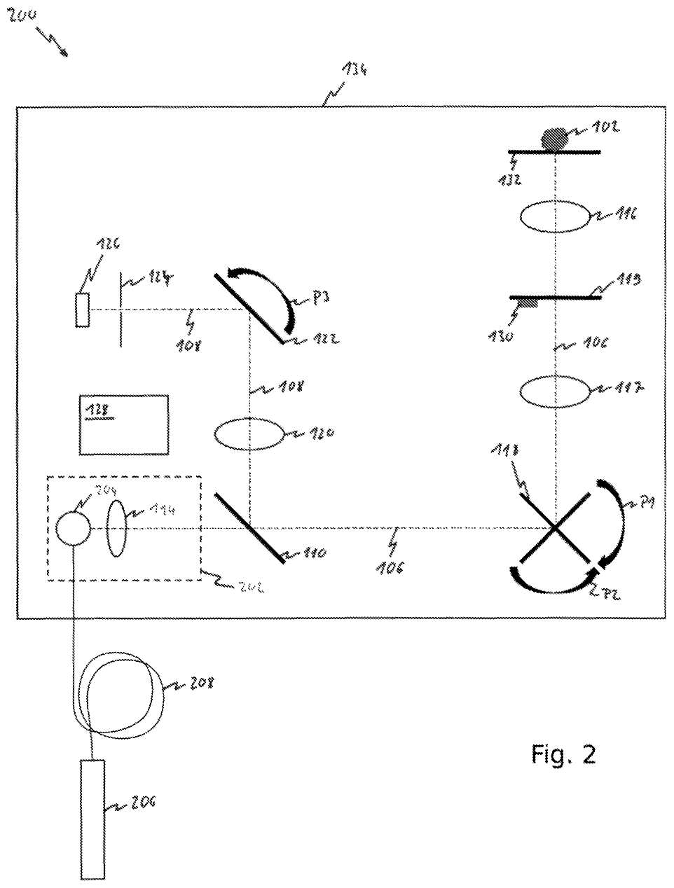

FIG. 2 shows a schematic view of a confocal microscope 200 according to a further exemplary embodiment.

The confocal microscope 200 according to FIG. 2 differs from the confocal microscope 100 of FIG. 1 in that the illumination unit 202 comprises an interface 204 with the aid of which the confocal microscope 200 is connectable to an external illumination light source 206. The interface 204 is configured as a fiber coupler purely by way of example. An external illumination light source 206 which is not part of the confocal microscope 200 is connected to the illumination unit 202 via an optical fiber 208. The illumination light generated by the external illumination light source 206 is coupled into the illumination unit 202 via the optical fiber 208 and the interface 204 and shaped by the illumination unit 202 to create the illumination light beam.

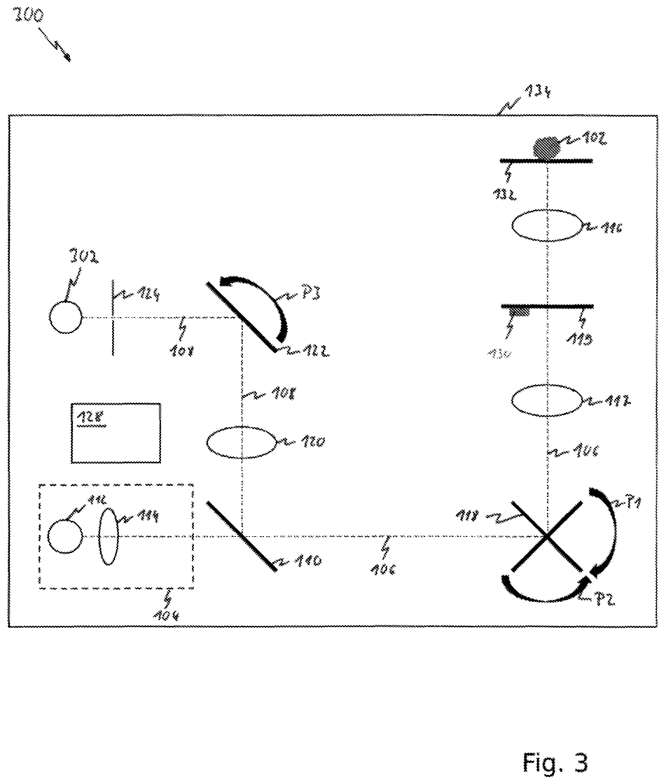

FIG. 3 shows a schematic view of a confocal microscope 300 according to a further exemplary embodiment.

The confocal microscope 300 of FIG. 3 differs from the confocal microscope 100 of FIG. 1 in that the detection beam path 108 includes a further interface 302 with the aid of which the confocal microscope 100 is connectable to an external detector unit. The further interface 302 can be, for example, a fiber coupler so that the external detector unit can be coupled into the detection beam path 108 with the aid of an optical fiber. Alternatively, the further interface 302 can also be formed by an adapter for the external detector unit, which can comprise an adapter optics.

FIG. 4 shows a flowchart of the method for adjusting a confocal microscope 100.

The method can be executed, in particular, by the control unit 128 of one of the confocal microscopes 100, 200, 300 according to FIG. 1, 2 or 3. The method is automatically executed, in particular, when the confocal microscope 100, 200, 300 is put into operation, for example, when the confocal microscope 100, 200, 300 is switched on. Alternatively, or additionally, the method can be automatically executed regularly after the passage of a predetermined time interval.

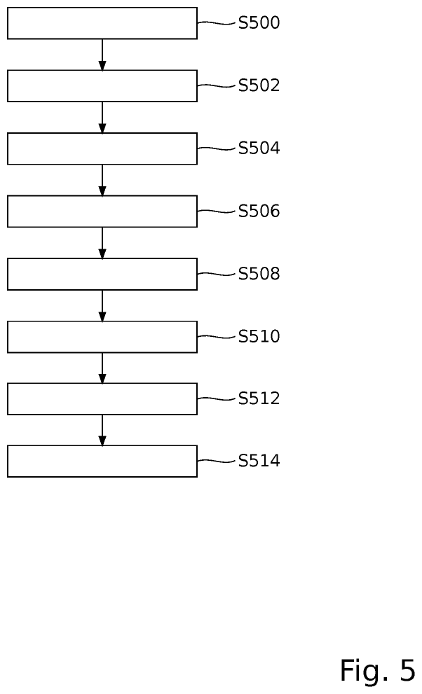

In step S400, the method is started. In step S402, the control unit 128 controls the illumination unit 104, 202 to generate the illumination light beam. When the external illumination light source 112 is used, the control unit 128 can also drive, in particular, the external illumination light source 206. In step S404 the control unit 128 controls the scanning unit 118 in such a manner that the test object 130 arranged in the plane of the intermediate image 119 is illuminated by the illumination light beam. The control unit 128 can also alternatively drive the microscope table 132 in such a manner that the test object 130 is traversed into the illumination beam light beam. In step S406, the control unit 128 adjusts the light deflection element 122 until the intensity, detected by the sensor element 126, of the detection light coming from the test object 130 has been optimized. In particular, the control unit 128 adjusts the light deflection element 122 until the intensity, detected by the sensor element 126, of the detection light coming from the test object 130 has been maximized. Step S406 will be described in more detail with reference to FIGS. 4 and 5. In step S408, the method ends.

FIG. 5 shows a flowchart of the sub-method of the method of FIG. 4 according to a first exemplary embodiment.

The sub-method of FIG. 5 is executed in step S406 to optimally adjust the light deflection element 122. In the sub-method of FIG. 5, the light deflection element 122 is iteratively adjusted. The sub-method starts at step S500. In step S502, the control unit 128 adjusts the light deflection element 122 along a first axis in a plurality of successive steps. Herein, the control unit 128 adjusts the light deflection element 122 with a predetermined first step width and within a first adjustment range. At each step, in which the light deflection element 122 is adjusted along the first axis, the sensor element 126 detects the intensity of the detection light coming from the test object 130. In step S504, the control unit 128 adjusts the light deflection element 122 to a position along the first axis for which the detected intensity of the detection light coming from the test object 130 is at a maximum.

In step S506, the control unit 128 adjusts the light deflection element 122 along a second axis in a plurality of successive steps. Preferably, the second axis is perpendicular to the first axis. Herein, the control unit 128 adjusts the light deflection element 122 with a predetermined second step width and within a second adjustment range. The first step width and the second step width can have the same size. Also, at each step, in which the light deflection element 122 is adjusted along the second axis, the sensor element 126 detects the intensity of the detection light coming from the test object 130. In step S508, the control unit 128 adjusts the light deflection element 122 to a position along the second axis for which the detected intensity of the detection light coming from the test object 130 is at a maximum. Steps S502 to S508 are repeated until the change in position of the light deflection element 122 along the first axis and the second axis in each of steps S504 and S508 is smaller than a predetermined value.

In the optional step S510, the first adjustment range and/or the second adjustment range are enlarged before steps S502 to S508 are repeated with the new adjustment ranges. In the optional step S512, the control unit 128 controls the pinhole diaphragm 124 in such a manner that the diameter of the pinhole diaphragm 124 is enlarged before steps S502 to S508 are repeated. Steps S510 and S512 are executed, in particular, when the intensities detected in each of steps S502 and S506 have a value that is smaller than a predetermined intensity value. Steps S510 and S512 can be executed even if a maximum cannot be determined in the steps, i.e., when the iterative adjustment of the light deflection element 122 does not converge. For example, steps S510 and S512 can be executed when after a predetermined number of repeats of steps S502 to S508 the change in position of the light deflection element 122 along the first axis and the second axis is still larger than the predetermined value. At step S514, the sub-method ends.

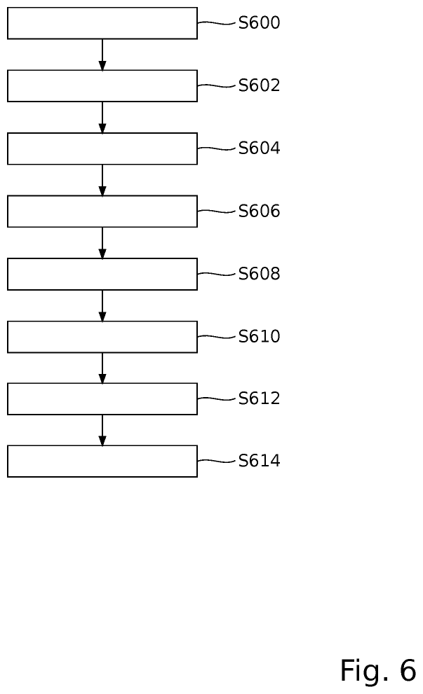

FIG. 6 shows a flowchart of the sub-method of the method of FIG. 4 according to a second exemplary embodiment.

The sub-method of FIG. 6 is executed in step S406 to optimally adjust the light deflection element 122 and provides an alternative to the sub-method of FIG. 5. In the sub-method of FIG. 6, the adjustment of the light deflection element 122 is carried out using an intensity distribution measured by the confocal microscope 100, 200.

The sub-method starts at step S600. In step S602, the control unit 128 adjusts the light deflection element 122 along the first axis in a plurality of successive steps. Herein, the control unit 128 adjusts the light deflection element 122 with a predetermined first step width and within a first adjustment range. At each step, in which the light deflection element 122 is adjusted along the first axis, the sensor element 126 detects the intensity of the detection light coming from the test object 130. In step S604, the control unit 128 adjusts the light deflection element 122 along the second axis by a predetermined step width. The second axis is preferably perpendicular to the first axis. Steps S602 and S604 are repeated in an alternating manner until the light deflection element 122 has been adjusted along the second axis by a predetermined value corresponding to a second adjustment range.

In step S606, the control unit 128 determines a two-dimensional intensity distribution from each of the intensities detected in step S602. In step S606, the control unit 128 further determines a center of gravity or a maximum, in particular the global maximum, of the two-dimensional intensity distribution. In the optional step S608, the first adjustment range and/or the second adjustment range are enlarged before steps S602 and S604 are repeated with the new adjustment ranges. In the optional step S610, the pinhole diaphragm 124 is driven in such a manner that the diameter of the pinhole diaphragm 124 is enlarged before steps S602 and S604 are repeated. The optional steps S608 and S610 are carried out, in particular, when a center of gravity and/or a maximum of the intensity distribution cannot be determined. The optional steps S608 and S610 can be executed even when the value of the intensity distribution at the center of gravity or the maximum is smaller than the predetermined intensity value.

In step S612, the control unit 128 adjusts the light deflection element 122 to a position along the first axis and the second axis which corresponds to the center of gravity or the maximum of the two-dimensional intensity distribution. The sub-method then ends at step S614.

The expression “and/or” comprises all combinations of one or more of the associated listed elements and can be “/” in short.

Even if some aspects have been described in the context of an apparatus, it is clear that these aspects also represent a description of the corresponding method, wherein a block or an apparatus corresponds to a method step or a function of a method step. In analogy to this, aspects described in the context of a method step also represent a description of a corresponding block or element or a property of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

100 confocal microscope
102 specimen
104 illumination unit
106 main beam path
108 detection beam path
110 beam splitter
112 illumination light source
114 optical element
116 objective
117 scanning ocular
118 scanning unit
119 intermediate image
120 pinhole diaphragm optics
122 light deflection element
124 pinhole diaphragm
126 sensor element
128 control unit
130 test object
132 microscope table
134 housing
200 confocal microscope
202 illumination unit
204 interface
206 illumination light source
208 optical fiber
300 confocal microscope
302 interface
P1, P2, P3 arrow

1. A confocal microscope, comprising:
an illumination unit configured to generate an illumination light bundle,
an imaging optics configured to receive detection light and to guide the detection light to further elements of the confocal microscope,
a scanner configured to:
direct the illumination light bundle into the imaging optics and deflect the illumination light bundle to generate a scanning illumination, and
receive the detection light from the imaging optics and direct the detection light into a detection beam path of the confocal microscope,
a sensor disposed in the detection beam path,
a pinhole diaphragm arranged in the detection beam path upstream of the sensor,
an adjustable light deflector arranged in the detection beam path and configured to direct the detection light through the pinhole diaphragm onto the sensor, and
a controller configured to:
control the scanner to adjust the confocal microscope in such a manner that the illumination light bundle is directed onto a test object, and
control the light deflector in such a manner that an intensity of the detection light coming from the test object, as detected by the sensor, is optimized.

2. The confocal microscope according to claim 1, wherein the controller is configured to carry out the adjustment of the confocal microscope each time the confocal microscope is switched on.

3. The confocal microscope according to claim 1, wherein the controller is configured to carry out the adjustment of the confocal microscope whenever a predetermined time interval has elapsed.

4. The confocal microscope according to claim 1, wherein the illumination light bundle is configured to excite fluorescent materials to generate fluorescent light.

5. The confocal microscope according to claim 4, wherein the test object is excitable by the illumination light bundle to generate the fluorescent light.

6. The confocal microscope according to claim 1, further comprising the test object, wherein the test object is arranged within a housing of the confocal microscope.

7. The confocal microscope according to claim 1, wherein the illumination unit comprises an illumination light source, configured to generate illumination light; and wherein the illumination unit is configured to shape the illumination light generated by the illumination light source to create the illumination light bundle.

8. The confocal microscope according to claim 1, wherein the illumination unit comprises a fiber coupler, wherein the confocal microscope is connectable to an external illumination light source via the fiber coupler, and wherein the illumination unit is configured to shape illumination light generated by the external illumination light source to create the illumination light bundle.

9. The confocal microscope according to claim 1, further comprising a beam splitter configured to direct the illumination light bundle onto the scanner and to direct the detection light received from the imaging optics into the detection beam path.

10. A method of adjusting the confocal microscope according to claim 1, wherein the illumination light bundle is directed onto the test object and the light deflector is adjusted until the intensity of the detection light coming from the test object is optimized.

11. The method according to claim 10, comprising:
a) adjusting the light deflector in a first plurality of successive steps at a predetermined step width along a first axis within a first adjustment range;
b) detecting the intensity of the detection light coming from the test object in each step of the first plurality of successive steps along the first axis;
c) adjusting the light deflector to a position along the first axis, for which the detected intensity of the detection light coming from the test object is at a maximum;
d) adjusting the light deflector in a second plurality of successive steps at a predetermined second step width along a second axis within a second adjustment range;
e) detecting the intensity of the detection light coming from the test object in each step of the second plurality of successive steps along the second axis; and
f) adjusting the light deflector to a position along the second axis, for which the detected intensity of the detection light coming from the test object is at a maximum.

12. The method according to claim 11, wherein the steps a) to f) are repeated until each change in position in steps c) and f) is smaller than a predetermined value.

13. The method according to claim 11, further comprising:
if the intensity detected in each step of steps b) and e) has a value that is smaller than a predetermined intensity value and/or if the maximum cannot be determined in steps c) and/or f), enlarging the first adjustment range and/or the second adjustment range, and repeating steps a) to f).

14. The method according to claim 11, further comprising:
based on the intensity detected in each step of steps b) and e) having a value that is smaller than a predetermined intensity value and/or if the maximum cannot be determined in steps c) and/or f), enlarging the diameter of the pinhole diaphragm, and repeating steps a) to f).

15. The method according to claim 10, comprising:
a) adjusting the light deflector in a plurality of successive steps at a first predetermined step width along a first axis within a first adjustment range;
b) detecting the intensity of the detection light coming from the test object in each step of the plurality of successive steps along the first axis;
c) adjusting the light deflector at a second predetermined step width along a second axis;
d) repeating steps a) to c) until the light deflector has been adjusted along the second axis by a predetermined value which corresponds to a second adjustment range;
e) determining a two-dimensional intensity distribution from each of the intensities detected in step b);
f) determining a center of gravity or a maximum in the two-dimensional intensity distribution; and
g) adjusting the light deflector to a position along the first axis and the second axis corresponding to the center of gravity or the maximum of the two-dimensional intensity distribution.

16. The method according to claim 15, further comprising:
based on each of the intensities detected in step e) having a value that is smaller than a predetermined intensity value and/or the center of gravity or the maximum not being determinable in step f), enlarging the first adjustment range and/or the second adjustment range, and repeating steps a) to g).

17. The method according to claim 15, further comprising:
based on each of the intensities detected in step e) having a value that is smaller than a predetermined intensity value and/or the center of gravity or the maximum not being determinable in step f), enlarging the diameter of the pinhole diaphragm, and repeating steps a) to g).
